(19) United States
(12) Patent Application Publication
(10) Pub. No.: US 2003/0167651 A1
(43) Pub. Date: Sep. 11, 2003

(54) Tape measure magnet and method therefor

(76) Inventor: Richard F. Pedersen, Las Vegas, NV (US)

Correspondence Address: WEISS & MOY PC, 4204 NORTH BROWN AVENUE, SCOTTSDALE, AZ, 85251, US

(21) Appl. No.: 10/090,029

(22) Filed: Mar. 5, 2002

(51) Int. Cl. G01B 3/10

(52) U.S. Cl. 33/758; 33/768

(57) ABSTRACT

A tape measure magnet having a magnet coupled to the tab on the extendable tape end of a tape measure, allowing a worker to extend the tape measure in order to reach and retrieve small metal objects without leaving his or her work environment.

### FIELD OF THE INVENTION

This invention relates generally to tape measures and, more specifically, to a tape measure having a magnet attached to the extendable tape end, allowing the tape measure to also be used to pick up metal objects.

### BACKGROUND OF THE INVENTION

Construction workers and other laborers often work on ladders and other hard to reach areas. To minimize the inconvenience of going up and down a ladder every time a tool or other item is needed, many people use a utility belt or some other means for bringing as many tools as possible to the hard to reach area. Such utility belts or bags often contain commonly used tools, such as a hammer, nails, a tape measure, and the like. Nevertheless, some items are accidentally left behind or drop from the worker's perch, leaving them out of reach below or to a side. This situation requires the frustrating and time-consuming effort of extricating one's self from one's work environment to pick up a loose item before returning to work. This process is not only a waste of time, it can often be very dangerous, and even life-threatening. Every time a person raises or lowers himself from a ladder or other high perch, he is running the risk of an accidental fall.

It is often the case that small metallic objects, such as nails and screws, fall or are left behind. One solution for retrieving these items without having to go back down from a ladder or roof would be to use a magnet tied to the end of some long object such as a string. There are several problems with this approach, however. First, the string only allows a worker to accurately reach objects that are directly below him, since the magnet will hang down at a ninety degree angle to the ground. Additionally, a string is likely to get tangled or caught on some other object in the work area or surrounding environment.

A need therefore existed for a magnet coupled to the extendable tape end of a tape measure, allowing a user to reach and retrieve small metal objects such as nails and screws without having to leave his or her work environment.

### SUMMARY OF THE INVENTION

An object of the present invention is to provide a tape measure having a magnet coupled to an extendable tape end and capable of allowing a user to reach and retrieve small metal objects without leaving the work environment.

### BRIEF DESCRIPTION OF THE PREFERRED EMBODIMENTS

In accordance with one embodiment of the present invention, a tape measure magnet is disclosed, comprising, in combination, a spring-loaded tape measure having an extendable tape housed inside a casing, the tape has a first end having a tab coupled thereto, and a magnet having a tab coupling side and an attracting side, the tab coupling side is dimensioned to be coupled to the tab of the first end of the tape, the attracting side of the magnet has sufficient attractive force to retain metal objects in a fixed position relative thereto when the metal objects are brought into proximity with the attracting side of the magnet.

In accordance with another embodiment of the present invention, a method for retrieving metallic objects from a distance is disclosed, comprising, in combination, the steps of providing a spring-loaded tape measure having an extendable tape housed inside a casing, the tape has a first end having a tab coupled thereto, providing a magnet having a tab coupling side and an attracting side, the tab coupling side is dimensioned to be coupled to the tab of the first end of the tape, the attracting side of the magnet has sufficient attractive force to retain metal objects in a fixed position relative thereto when the metal objects are brought into proximity with the attracting side of the magnet, extending the first end of the tape, bringing the magnet into proximity with a metal object so that the magnet is able to retain the metal object in a fixed position relative thereto, and retracting the first end of the tape to fetch the metal object to the casing of the tape measure.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of the preferred embodiment of the tape measure magnet of the present invention, showing a magnet capable of being coupled to the tab of the first end of the tape as well as to the casing of the tape measure.

FIG. 2 is an end view of the tape measure of FIG. 1, showing the first end of the tape in a retracted position.

FIG. 3 is a perspective view of the magnet of the tape measure magnet of the present invention.

FIG. 4 is a partial, side view of the first end of the tape of the tape measure, showing the tab of the first end of the tape coupled to the magnet.

FIG. 5 is a partial, perspective view of an alternative embodiment of the tape measure magnet of the present invention, showing how the magnet can be coupled to the tab of the first end of the tape through a slot in the tab.

FIG. 6 is a back view of the tab of the first end of the tape of FIG. 5, showing the slot in the tab.

### DETAILED DESCRIPTION OF THE PREFERRED EMBODIMENTS

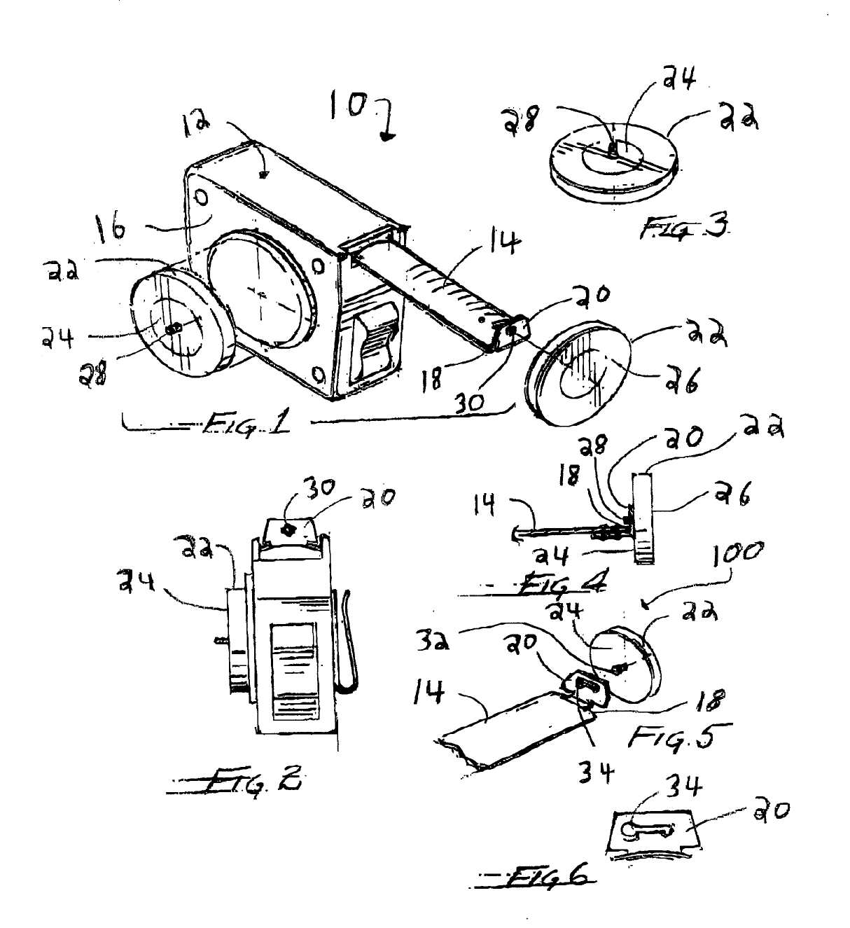

Referring to FIGS. 1-2 reference number 10 refers generally to the preferred embodiment of the tape measure magnet of the present invention. The tape measure magnet 10 comprises a spring-loaded tape measure 12 having an extendable tape 14 housed inside a casing 16. The tape 14 has a first end 18 having a tab 20 coupled thereto. The tape measure magnet 10 further comprises a magnet 22 having a tab coupling side 24 and an attracting side 26. The tab coupling side 24 is dimensioned to be coupled to the tab 20 of the first end 18 of the tape 14. The attracting side 26 of the magnet 22 has sufficient attractive force to retain metal objects (not shown), such as nails or screws, in a fixed position relative thereto when the metal objects are brought into proximity with the attracting side 26 of the magnet 22. In this way, a user can extend the first end 18 of the tape 14 in virtually any direction in order to reach and retrieve small metal objects. After the objects have been retained by the magnet 22, the user simply retracts the first end 18 of the tape 14 into the casing 16 of the spring-loaded tape measure 12 to retrieve the object.

In the preferred embodiment, the tab coupling side 24 of the magnet 22 comprises a screw 28 (shown in FIGS. 1, 3 and 4) dimensioned to be coupled to a threaded aperture 30 (shown in FIGS. 1-2) in the tab 20.

Referring now to FIGS. 5-6, an alternative embodiment or the tape measure magnet 10, hereinafter 100, is shown. The tape measure magnet 100 is essentially the same as before although instead of a screw 28, the tab coupling side 24 of the magnet 22 comprises a prong 32 dimensioned to be coupled to a slot 34 in the tab 20. While the tape measure magnet 10 and the tape measure magnet 100 use a screw 28 and a prong 32, respectively, it should be clearly understood that substantial benefit could be derived from an alternative embodiment of the tape measure magnets 10 and 100 in which the tab coupling side 24 of the magnet 22 is coupled to the tab 20 by some other means, such as by a clip.

In the preferred embodiment, the casing 16 of the spring-loaded tape measure 12 has at least one metal side dimensioned to receive the attracting side 26 of the magnet 22 so that the magnet 22 can be retained in a fixed position relative to the metal side of the casing 16 when the attracting side 26 of the magnet 22 is brought into proximity with the metal side of the casing 16. This allows the magnet 22 to be “stored” for easy access on the casing 16 of the tape measure 12 when the magnet 22 is not needed.

While the invention has been particularly shown and described with reference to preferred embodiments thereof, it will be understood by those skilled in the art that the foregoing and other changes in form and details may be made therein without departing from the spirit and scope of the invention.

I claim:

1. A tape measure magnet, comprising, in combination:
a spring-loaded tape measure having an extendable tape housed inside a casing, said tape has a first end having a tab coupled thereto; and
a magnet having a tab coupling side and an attracting side, said tab coupling side is dimensioned to be coupled to said tab of said first end of said tape, said attracting side of said magnet has sufficient attractive force to retain metal objects in a fixed position relative thereto when said metal objects are brought into proximity with said attracting side of said magnet.

2. Said tape measure magnet of claim 1 wherein said tab coupling side of said magnet comprises a screw dimensioned to be coupled to said tab by a threaded aperture defined therein.

3. Said tape measure magnet of claim 1 wherein said tab coupling side of said magnet comprises a prong dimensioned to be coupled to said tab by a slot defined therein.

4. Said tape measure magnet of claim 1 wherein said casing has at least one metal side dimensioned to receive said attracting side of said magnet so that said magnet can be retained in a fixed position relative to said metal side of said casing when said attracting side of said magnet is brought into proximity with said metal side of said casing.

5. A method for retrieving metallic objects from a distance comprising, in combination, said steps of:
providing a spring-loaded tape measure having an extendable tape housed inside a casing, said tape has a first end having a tab coupled thereto;
providing a magnet having a tab coupling side and an attracting side, said tab coupling side is dimensioned to be coupled to said tab of said first end of said tape, said attracting side of said magnet has sufficient attractive force to retain metal objects in a fixed position relative thereto when said metal objects are brought into proximity with said attracting side of said magnet;
extending said first end of said tape;
bringing said magnet into proximity with a metal object so that said magnet is able to retain said metal object in a fixed position relative thereto; and
retracting said first end of said tape to fetch said metal object to said casing of said tape measure.

6. The method of claim 5 further comprising the steps of:
providing a screw coupled to said tab coupling side of said magnet and dimensioned to be coupled to said tab by a threaded aperture defined therein; and
screwing said screw of said tab coupling side of said magnet into said tab to secure said magnet to said tab.

7. The method of claim 5 further comprising the steps of:
providing a prong coupled to said tab coupling side of said magnet and dimensioned to be coupled to said tab by a slot defined therein; and
coupling said prong of said tab coupling side of said magnet into said tab to secure said magnet to said tab.

8. The method of claim 5 wherein said casing has at least one metal side dimensioned to receive said attracting side of said magnet.

9. The method of claim 8 further comprising the step of positioning said attracting side of said magnet into proximity with said metal side of said casing so that said magnet can be retained in a fixed position relative to said metal side of said casing.
